(19) United States
(12) Patent Application Publication
(10) Pub. No.: US 2008/0147389 A1
(43) Pub. Date: Jun. 19, 2008

(54) Method and Apparatus for Robust Speech Activity Detection

(75) Inventor: Dusan Macho, Arlington Heights, IL (US)

Correspondence Address: PRASS & IRVING LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/611,469

(22) Filed: Dec. 15, 2006

(51) Int. Cl. G10L 21/00

(52) U.S. Cl. 704/228

(57) ABSTRACT

A method and apparatus for robust speech activity detection is disclosed. The method may include calculating autocorrelations by filtering input signals using order statistic filtering, averaging the autocorrelations over a time period, obtaining a voiced speech feature from the averaged autocorrelations, classifying the input signal as one of speech and non-speech based on the obtained voiced speech feature, and outputting only the classified speech signals or the input signals along with the speech/non-speech classification information, to an automated speech recognizer.

### BACKGROUND OF THE INVENTION

1. Field of the Invention

The invention relates to speech detection in electronic devices.

2. Introduction

Effectiveness of many speech-related technologies and systems, such as Automatic Speech Recognition (ASR), Speech Coding, Speaker Identification/Verification, etc., depends greatly upon the ability to distinguish speech from noise (or from non-speech in general). In ASR systems, speech recognition accuracy in noisy environments is strongly affected by the ability of system to distinguish speech from non-speech. Noise that impacts recognition can be environmental and acoustic background noise from the user's surroundings or noise of an electronic nature generated in the communication system itself, for example. This noise impacts many electronic devices that rely upon speech recognition, such as global positioning systems (GPS) in automobiles, voice controlled telephones and stereos, etc. In a driving scenario, for example, if people are talking, the stereo is on, and/or the windows are down, a conventional speech recognition system will have a difficult time differentiating between speech and background noise.

### SUMMARY OF THE INVENTION

A method and apparatus for robust speech activity detection is disclosed. The method may include calculating autocorrelations by filtering input signals using order statistic filtering, averaging the autocorrelations over a time period, obtaining a voiced speech feature from the averaged autocorrelations, classifying the input signal as one of speech and non-speech based on the obtained voiced speech feature, and outputting only the classified speech signals or the input signals along with the speech/non-speech classification information, to an automated speech recognizer.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary diagram of a robust speech activity detector operating in a communications network in accordance with a possible embodiment of the invention;

FIG. 2 illustrates a block diagram of an exemplary wireless communication device having a robust speech activity detector in accordance with a possible embodiment of the invention; and

FIG. 3 is an exemplary flowchart illustrating one possible robust speech activity detection process in accordance with one possible embodiment of the invention.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The present invention comprises a variety of embodiments, such as a method and apparatus and other embodiments that relate to the basic concepts of the invention.

This invention concerns robust speech activity detection based on a voiced speech detection process. The main motivations and assumptions behind the invention are:
Periodic voiced portions of speech are very robust in noisy environments
Many real-world noises do not show periodic behavior

As a consequence, the amount of periodicity within the range of typical human fundamental frequency F0 (also known as pitch) in a segment of waveform would indicate the presence or absence of speech and thus provide a robust feature for many real-world noise situations.

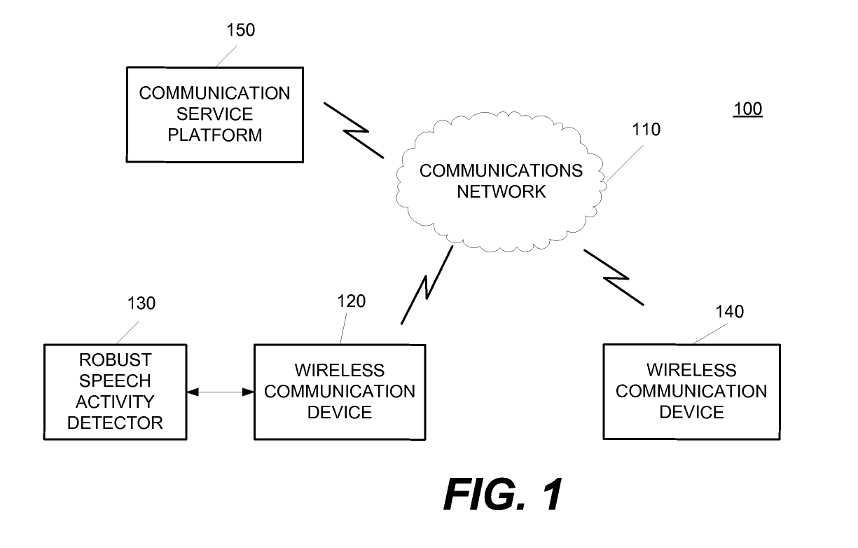

FIG. 1 illustrates an exemplary diagram of a robust speech activity detector 120 operating in a communications network environment 100 in accordance with a possible embodiment of the invention. In particular, the communications network environment 100 includes communications network 110, wireless communication device 140, communications service platform 150, and robust speech activity detector 130 coupled to wireless communication device 120. Communications network 110 may represent any network known to one of skill in the art, including a wireless telephone network, cellular network, a wired telephone network the Internet, wireless computer network, intranet satellite radio network, etc. Wireless communication devices 120, 140 may represent wireless telephones, wired telephones, personal computers, portable radios, personal digital assistants (PDAs), MP3 players, satellite radio, satellite television, global positioning system (GPS) receiver, etc.

The communications network 110 may allow wireless communication device 120 to communicate with other wireless communication devices, such as wireless communication device 140. Alternatively, wireless communication device 120 may communicate through communications network 110 to a communications service platform 150 that may provide services such as media content, navigation, directory information, etc. to GPS devices, satellite radios, MP3 players, PDAs, radios, satellite televisions, etc.

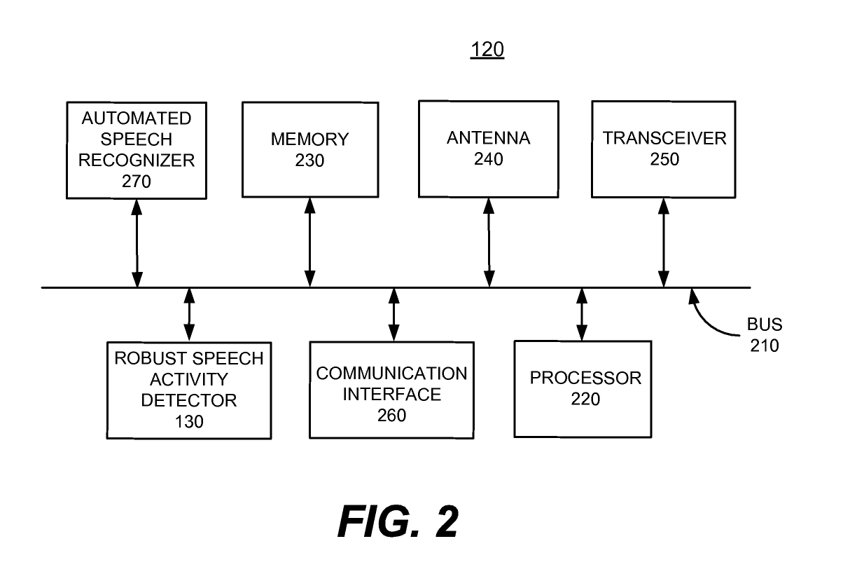

FIG. 2 illustrates a block diagram of an exemplary wireless communication device 120 having a robust speech activity detector 130 in accordance with a possible embodiment of the invention. The exemplary wireless communication device 120 may include a bus 210, a processor 220, a memory 230, an antenna 240, a transceiver 250, a communication interface 260, automated speech recognizer 270, and robust speech activity detector 130. Bus 210 may permit communication among the components of the wireless communication device 120.

Processor 220 may include at least one conventional processor or microprocessor that interprets and executes instructions. Memory 230 may be a random access memory (RAM) or another type of dynamic storage device that stores information and instructions for execution by processor 220. Memory 230 may also include a read-only memory (ROM) which may include a conventional ROM device or another type of static storage device that stores static information and instructions for processor 220.

Transceiver 250 may include one or more transmitters and receivers. The transceiver 250 may include sufficient functionality to interface with any network or communications station and may be defined by hardware or software in any manner known to one of skill in the art. The processor 220 is cooperatively operable with the transceiver 250 to support operations within the communications network 110.

Communication interface 260 may include any mechanism that facilitates communication via the communications network 110. For example, communication interface 260 may include a modem. Alternatively, communication interface 260 may include other mechanisms for assisting the transceiver 250 in communicating with other devices and/or systems via wireless connections.

The wireless communication device 120 may perform such functions in response to processor 220 by executing sequences of instructions contained in a computer-readable medium, such as, for example, memory 230. Such instructions may be read into memory 230 from another computer-readable medium, such as a storage device or from a separate device via communication interface 260.

The communications network 110 and the wireless communication device 120 illustrated in FIGS. 1-2 and the related discussion are intended to provide a brief, general description of a suitable computing environment in which the invention may be implemented. Although not required, the invention will be described, at least in part, in the general context of computer-executable instructions, such as program modules, being executed by the wireless communication device 120, such as a communications server, or general purpose computer. Generally, program modules include routine programs, objects, components, data structures, etc. that perform particular tasks or implement particular abstract data types. Moreover, those skilled in the art will appreciate that other embodiments of the invention may be practiced in communication network environments with many types of communication equipment and computer system configurations, including cellular devices, mobile communication devices, personal computers, hand-held devices, multi-processor systems, microprocessor-based or programmable consumer electronics, and the like.

For illustrative purposes, the robust speech activity detection process will be described below in relation to the block diagrams shown in FIGS. 1 and 2.

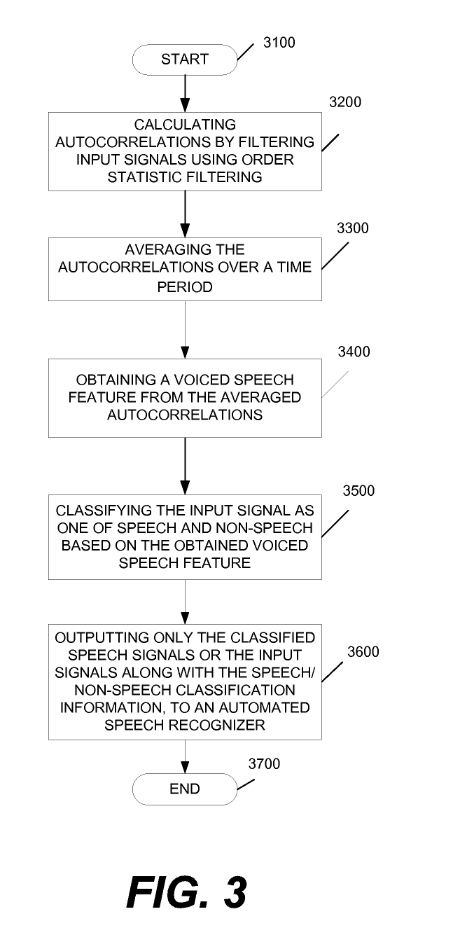

FIG. 3 is an exemplary flowchart illustrating some of the basic steps associated with a robust speech activity detection process in accordance with a possible embodiment of the invention. The process begins at step 3100 and continues to step 3200 where the robust speech activity detector 130 calculates autocorrelations by filtering input signals received by the wireless communication device 120 using order statistic filtering.

In a common ASR system, the input waveform is framed into overlapping frames, for example 25/10 ms frame length/shift is used in the Advanced Front End ETSI standard. As one of skill in the art may appreciate, the autocorrelation function measures the amount of periodicity in signal. As in conventional systems, if autocorrelation is applied directly to the input speech signal, it has the following disadvantages:
a) The peak corresponding to the fundamental frequency F0 in the autocorrelation function of sounds that have a high-frequency dominant formant (such as /i:/) is not clearly observed;
b) High computational load.

To avoid these drawbacks, the robust speech activity detector 130 uses a nonlinear filtering technique called Order Statistic Filtering (OSF). One of skill in the art will appreciate that OSFs are used in robust edge detection in the image processing field. Also in the speech processing field, OSF is applied to the time sequence of speech features to increase their robustness.

In one exemplary embodiment, the robust speech activity detector 130 applies a simple form of OSF—the maximum OSF—directly to the input signal waveform to extract its envelope. The output of such maximum OSF is the maximum sample value of an interval of samples surrounding the current one. For example, a maximum OSF of order 3 (OSF(3)) may be used in this implementation. Thus, the output at the time index n is y(n)=max[x(n−1), x(n), x(n+1)]. This may be followed by a selection of every second sample and a mean removal, for example. Higher order OSF may suggest a higher sample reduction ratio than the mentioned 2:1 ratio. The sample reduction can be applied without previous low-pass filtering due to a low energetic content at high frequencies in the signal after OSF(3) (the minor aliasing is present but is not harmful to the purpose of the invention). Thus, a lesser number of samples are now considered which cuts the computational cost of autocorrelation to one fourth of the original autocorrelation. An important property will be shown by the resulting autocorrelation function because clear peaks at particular lags corresponding to F0 will appear even in the case of sounds with high-frequency dominant formants.

Note that not all autocorrelation lags have to be calculated. Only one side of autocorrelation is of interest; additionally, only the autocorrelation lags corresponding for example to the F0 range of 60-200 Hz may be computed, while higher F0 frequencies will have in this range their second autocorrelation peak. Thus, further computation reduction is achieved. The resulting autocorrelations are normalized by their value at lag=0, so that the range is between −1.0 and 1.0. In any event, the autocorrelation function of voiced speech calculated in the way described above will show a high robustness to a wide range of non-stationary non-periodic noises.

At step 3300, the robust speech activity detector 130 averages the autocorrelations over a time period. The time averaging of autocorrelations is an important step that helps to remove the spurious peaks produced by autocorrelations of noise. It is assumed that in voiced speech signal, the consecutive autocorrelation functions have peaks and valleys at similar positions, while in noise signal the autocorrelation peaks and valleys will show random behavior.

To account for a possible F0 change along the time, before the autocorrelation functions are averaged, a small lag shift (for example 1 or 2) in the consecutive autocorrelation is tested for. Allowing a maximum shift of 1 lag, for example, if 1-lag left shift, or 1-lag right shift between the two consecutive autocorrelations produces a higher maximum value in the resulting average autocorrelation, the autocorrelations may be averaged using this lag shift instead of the direct-no-shift averaging. In total, 5 consecutive autocorrelations may be averaged in this way, for example.

At step 3400, the robust speech activity detector 130 obtains a voiced speech feature from the averaged autocorrelations. As a voiced speech feature, the value of the maximum of the above described autocorrelation function from a predetermined lag interval may used. At this stage of processing, the effect of a very low-frequency periodic noise may be reduced. The autocorrelations of such noise show a wide peak around lag=0 and this value changes relatively slowly with the lag change when compared to the autocorrelation of a voiced speech signal. To reduce this high value, the minimum autocorrelation value from the interval of positions +/−6 for example, around the position of the selected autocorrelation maximum peak may be compared to the value of the peak. If this minimum value is higher than half of the peak value, it may be subtracted from the peak value.

At step 3500, the robust speech activity detector 130 classifies the input signals as a sequence of speech input and non-speech input signals based on the obtained voiced speech feature. The speech/non-speech classification can be very simple at this point because the voiced speech feature is in the interval <−1, 1> and very intuitive: a high value of feature indicates a high amount of periodicity in the signal and thus indicates a high probability of voiced speech. Thus, a simple threshold may be used by the robust speech activity detector 130 make a reliable speech/non-speech decision. Note that because speech is not entirely voiced, a certain speech interval may be appended before and after each voiced speech interval detected by the robust speech activity detector 130.

At step 3600, the robust speech activity detector 130 may output either the speech/non-speech classification information with input signals, or only the classified speech to the automated speech recognizer 270. The automated speech recognizer 270 may then utilize this information in a desired way, for example using any known recognition algorithm to recognize the components of the classified speech (such as syllables, phonemes, phones, etc.) and output them for further processing to an natural language understanding unit, for example. The process goes to step 3700, and ends.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the robust speech activity detector 130 in FIGS. 1 and 2 each processing the content in various possible ways. It does not necessarily need to be one system used by all end users. Accordingly, the appended claims and their legal equivalents should only define the invention, rather than any specific examples given.

We claim:

1. A method for robust speech activity detection, comprising:
calculating autocorrelations by filtering input signals using order statistic filtering;
averaging the autocorrelations over a time period;
obtaining a voiced speech feature from the averaged autocorrelations;
classifying the input signals as a sequence of speech input and non-speech input signals based on the obtained voiced speech feature; and
outputting only the input signals along with the speech/non-speech classification information or the classified speech signals, to an automated speech recognizer.

2. The method of claim 1, wherein the input signals are filtered by applying the maximum order statistic filtering directly to a waveform of the input signal.

3. The method of claim 1, wherein classification between speech and non-speech is based on periodicity.

4. The method of claim 3, wherein if the periodicity level indicated by the voiced speech feature is above a predetermined threshold, the signal is classified as speech.

5. The method of claim 1, wherein the order statistic filtering is used to obtain the envelope of the input signal.

6. The method of claim 1, further comprising:
recognizing the classified speech.

7. An apparatus for robust speech activity detection, comprising:
an automated speech recognizer; and
a robust speech activity detector that calculates autocorrelations by filtering input signals using order statistic filtering, averages the autocorrelations over a time period, obtains a voiced speech feature from the averaged autocorrelations, classifies the input signals as a sequence of speech input and non-speech input signals based on the obtained voiced speech feature, and outputs only the input signals along with the speech/non-speech classification information or the classified speech signals, to an automated speech recognizer.

8. The apparatus of claim 7, wherein the robust speech activity detector filters the input signals by applying the maximum order statistic filtering directly to an input signal waveform.

9. The apparatus of claim 7, wherein classification between speech and non-speech is based on periodicity.

10. The apparatus of claim 9, wherein if the periodicity of the voiced speech feature is above a predetermined threshold, the robust speech activity detector classifies the signal as speech.

11. The apparatus of claim 7, wherein the robust speech activity detector uses the order statistic filtering to obtain the envelope of the input signal.

12. The apparatus of claim 7, wherein the automated speech recognizer recognizes the classified speech.

13. The apparatus of claim 7, wherein the apparatus is part of one of a voice-controlled GPS system, a voice-controlled phone, and a voice-controlled stereo.

14. A wireless communication device, comprising:
a transceiver that can send and receive signals;
an automated speech recognizer; and
a robust speech activity detector that calculates autocorrelations by filtering input signals using order statistic filtering, averages the autocorrelations over a time period, obtains a voiced speech feature from the averaged autocorrelations, classifies the input signals as a sequence of speech input and non-speech input signals based on the obtained voiced speech feature, and outputs only the input signals along with the speech/non-speech classification information or the classified speech signals, to an automated speech recognizer.

15. The wireless communication device of claim 14, wherein the robust speech activity detector filters the input signals by applying the maximum order statistic filtering directly to an input signal waveform.

16. The wireless communication device of claim 14, wherein classification between speech and non-speech is based on periodicity.

17. The wireless communication device of claim 16, wherein if the periodicity of the voiced speech feature is above a predetermined threshold, the robust speech activity detector classifies the signal as speech.

18. The wireless communication device of claim 14, wherein the robust speech activity detector uses the order statistic filtering to obtain the envelope of the input signal.

19. The wireless communication device of claim 14, wherein the automated speech recognizer recognizes the classified speech.

20. The wireless communication device of claim 14, wherein the wireless communication device is one of a voice-controlled GPS system, a voice-controlled phone, and a voice-controlled stereo.
